(19) United States
(12) Patent Application Publication
(10) Pub. No.: US 2015/0268426 A1
(43) Pub. Date: Sep. 24, 2015

(54) OPTICAL WIRING DEVICE AND METHOD FOR MANUFACTURING THE SAME

(71) Applicant: Kabushiki Kaisha Toshiba, Minato-ku (JP)

(72) Inventors: Kazuya OHIRA, Nerima (JP); Norio IIZUKA, Kawasaki (JP); Haruhiko Yoshida, Funabashi (JP); Mizunori Ezaki, Yokohama (JP); Hideto Furuyama, Yokohama (JP)

(73) Assignee: Kabushiki Kaisha Toshiba, Minato-ku (JP)

(21) Appl. No.: 14/657,319

(22) Filed: Mar. 13, 2015

(30) Foreign Application Priority Data
Mar. 20, 2014 (JP) 2014-058911

(51) Int. Cl. G02B 6/43; G02B 6/42; G02B 6/132; G02B 6/122

(52) U.S. Cl. CPC G02B 6/43; G02B 6/122; G02B 6/4283; G02B 6/132

(57) ABSTRACT

An optical wiring device of an embodiment includes a semiconductor substrate having a protruding structure, an optical device disposed on the protruding structure, an insulator disposed around the protruding structure and the optical device and a first optical waveguide optically coupled to the optical device. The insulator has a refractive index lower than a refractive index of the semiconductor substrate.

### CROSS-REFERENCE TO RELATED APPLICATION

This application is based upon and claims the benefit of priority from Japanese Patent Application No. 2014-058911, filed on Mar. 20, 2014, the entire contents of which are incorporated herein by reference.

### FIELD

Embodiments described herein relate generally to an optical wiring device and a method for manufacturing the same.

### BACKGROUND

In recent years, with increasing of integration density of LSIs, micronization of internal circuit patterns is progressing. With this progressing micronization, wiring cross-sectional areas decrease, and wiring resistances thus increase, whereby gaps between neighboring wirings are narrowed; and capacitances between wirings increase.

As a result, a wiring delay time determined by a wiring resistance and a wiring capacitance increases; thus, it becomes difficult to realize further speeding up of LSI. Further, as multicoring inside LSI and three-dimensional integration of memory are advanced, high-capacity transmission between cores or between a core and a memory becomes necessary, and the speed of transmission by electricity is a bottleneck for improving performance of LSI.

As a technology to solve the issue of the wiring delay associated with such high density of LSI, an optical wiring technology is attracting attention in which electric signals are replaced by optical signals. The optical wiring technology is a technology to transmit signals by using optical waveguides instead of metal wirings; and with the optical wiring technology it can be expected that the operation speed is further increased because wiring resistances and inter-wiring capacities associated with the above-mentioned micronization do not increase. For example, a photoelectric mixed LSI is proposed. In the photoelectric mixed LSI, signal processing is performed by function blocks by using electricity, and signal transmission between the function blocks is performed by using optical signals.

Regarding semiconductor lasers used as light sources in the optical wiring technology, elements having a size of some μm width and 100 μm length have been used in conventional optical communication. As described above, because the elements are much larger than transistors and wiring pitches in LSI, the size is a major impediment to replace the electric wirings by optical wirings.

### BRIEF DESCRIPTION OF THE DRAWINGS

FIGS. 1A and 1B are schematic diagrams of an optical wiring device of a first embodiment;

FIGS. 2A to 2C are schematic cross-sectional views of the optical wiring device of the first embodiment;

FIGS. 3A to 3G are schematic diagrams showing a method for manufacturing the optical wiring device of the first embodiment; and

FIG. 4 is a schematic cross-sectional view of an optical wiring device of a second embodiment.

### DETAILED DESCRIPTION

An optical wiring device of an embodiment includes: a semiconductor substrate having a protruding structure; an optical device disposed on the protruding structure; an insulator disposed around the protruding structure and the optical device, the insulator having a refractive index lower than a refractive index of the semiconductor substrate; and a first optical waveguide optically coupled to the optical device.

The embodiment of the present disclosure will be described below with reference to the drawings.

In the following description, the term “upper” refers to a direction toward the top of each drawings, the term “lower” refers to a direction toward the bottom of each drawing, and the terms have nothing to do with the direction of gravity.

### First Embodiment

An optical wiring device of the present embodiment includes: a semiconductor substrate having a protruding structure; an optical device disposed on the protruding structure; an insulator disposed around the protruding structure and the optical device, the insulator having a refractive index lower than a refractive index of the semiconductor substrate; and a first optical waveguide optically coupled to the optical device.

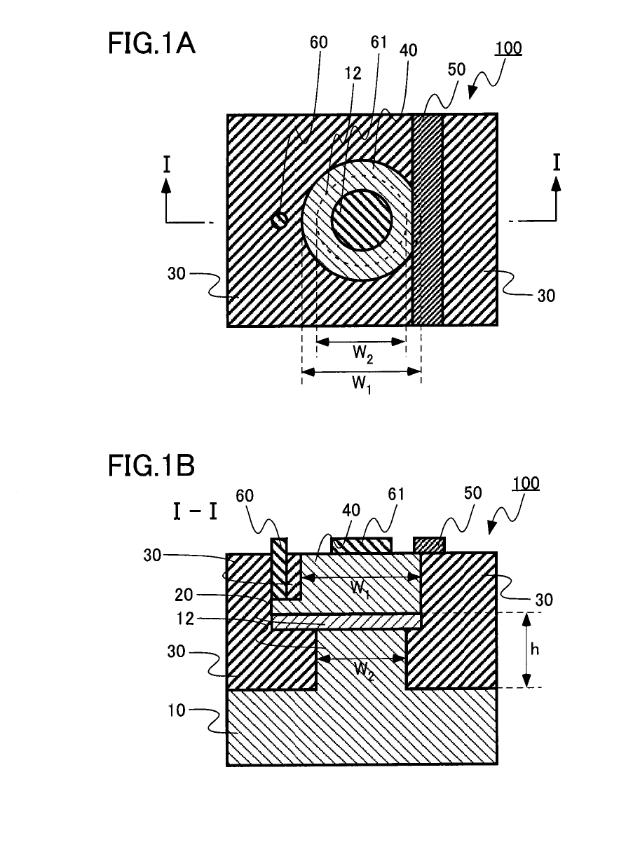

FIGS. 1A and 1B are schematic cross-sectional views of an optical wiring device 100 of the first embodiment.

A semiconductor substrate 10 preferably has a higher coefficient of thermal conductivity than an insulator 30 to be described later. For example, a substrate made of Si (silicon) is preferably used as the semiconductor substrate 10.

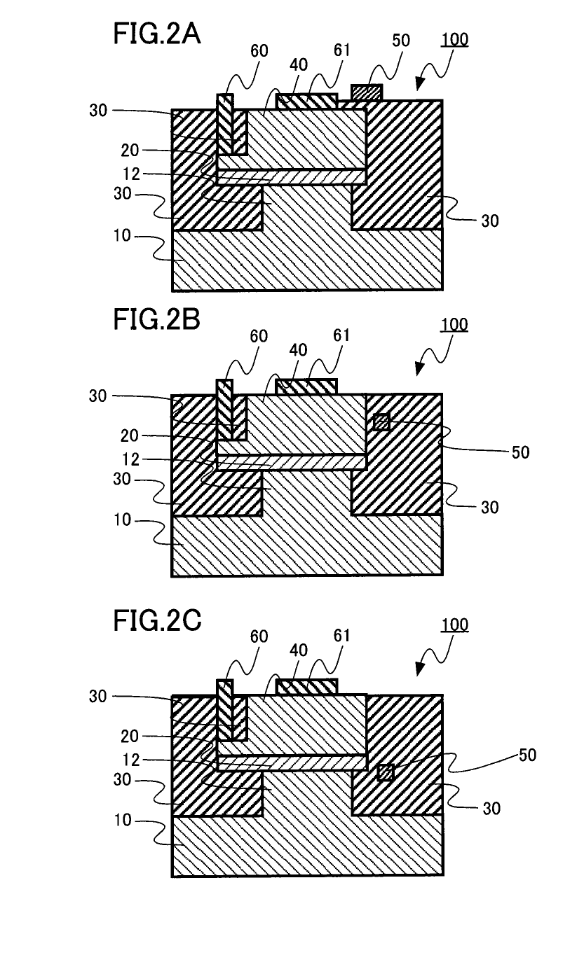

The semiconductor substrate 10 has a protruding structure 12. With reference to FIGS. 1A and 2B, a cross-section of the protruding structure 12 parallel to a main surface of the semiconductor substrate 10 has a circular shape. However, the shape of the cross-sectional shape is not limited to circle, and other shapes such as square, rectangle, and ellipse can be preferably used. In addition, an upper surface of the protruding structure 12 is preferably parallel to the main surface of the semiconductor substrate 10.

An optical device 40 is disposed on or above the protruding structure 12. The optical device 40 here is a light emitting element or a light receiving element, for example. The optical device 40 includes at least an active layer which emits or receives light. As the light emitting element, for example, a micro-ring laser which uses a resonator in a micro-ring structure as a small-sized light source or a micro-disk laser which uses a resonator in a micro-disk structure as a small-sized light source are preferably used. In addition, a lower surface of the optical device 40 is preferably parallel to the main surface of the semiconductor substrate 10.

As a shape of the optical device, a known shape is preferably used. An indium phosphide based compound semiconductor (InGaAsP, InGaAlAs) and a gallium arsenide based compound semiconductor (AlGaAs, InGaAs, InAs) can be preferably used as the optical device for higher efficiency and lower energy consumption.

The insulator 30 is disposed around the protruding structure 12 and the optical device 40. The insulator 30 has a refractive index lower than a refractive index of the semiconductor substrate 10. For example, SiO₂ (silicon dioxide) has insulation property and has a refractive index lower than Si; thus, SiO₂ is preferably used as the insulator 30 of the present embodiment.

A first optical waveguide 50 is optically coupled to the optical device 40, or optically coupled to the optical device 40 in a distributed coupling manner. The first optical waveguide 50 preferably includes at least one material selected from the second group consisting of amorphous silicon, polycrystalline silicon, and crystalline silicon because the silicon materials have a high refractive index.

An optical wiring device 100 may further include a second waveguide (not shown) made of dielectric or organic material and optically coupled to the first optical waveguide. As dielectric used for a second optical waveguide 52, different from the first optical waveguide, nitride oxide silicon or quartz in which P (phosphorus) or B (boron) is doped is preferably used, for example. Further, as an organic material used for the second optical waveguide 52, polyimide is preferably used, for example.

A lower electrode 60 is electrically connected to a lower part of the optical device 40. An upper electrode 61 is electrically connected to an upper part of the optical device 40. The lower electrode 60 and the upper electrode 61 are both electric wirings. The electric wirings are preferably formed of an AuZn alloy or an AuGe alloy, for example.

The optical wiring device 100 may include an electronic circuit (not shown) for driving the optical device 40.

An width W₂, of the protruding structure, in a plane parallel to the main surface of the semiconductor substrate is preferably not greater than a width W₁ of the optical device in a plane parallel to the main surface of the semiconductor substrate. Here, the width W₁ of the optical device is defined in the active layer of the optical device 40. On the other hand, if the width W₂ is too smaller than the width W₁, heat dissipation of the optical device 40 is poor; thus, the width W₂ is preferably greater than ¼ of the width W₁.

More preferably, the width W₂ should be about 8 μm, when the width W₁ is about 10 μm. Further, when the width W₁ is about 50 μm, the width W₂ should be about 46 μm. In addition, in order to prevent the light to be emitted or to be received by the optical device 40 from being absorbed in the protruding structure 12, the whole of the protruding structure 12 is preferably disposed inside a straight line drawn from an end of the optical device 40 to the main surface of the semiconductor substrate 10 so that the straight line is perpendicular to the main surface of the semiconductor.

A buffer layer 20 is disposed between the protruding structure 12 and the optical device 40. The buffer layer 20 includes at least one material selected from a first group consisting of metal, amorphous silicon, and polycrystalline silicon.

The buffer layer 20 may include a plurality of layers made of metal, amorphous silicon, or polycrystalline silicon.

A distance h between a bottom of the protruding structure 12 and the optical device 40 is preferably not less than A/n so that the light to be emitted or to be received by the optical device 40 is prevented from being absorbed in the semiconductor substrate 10. Here, the value A is a wavelength of the light to be emitted or to be received by the optical device 40, and the value n is a refractive index the insulator 30. On the other hand, if the distance h is too large, the protruding structure 12 hardly conducts heat generated in the optical device 40 to the semiconductor substrate 10. Accordingly, the distance h is preferably 5λ/n or lower and is more preferably 2λ/n or lower. Note that when the buffer layer 20 is disposed, the distance h includes the thickness of the buffer layer 20.

FIGS. 2A to 2C are schematic cross-sectional views showing preferable positions of the first optical waveguide 50 with respect to the optical device 40 in the optical wiring device 100 of the first embodiment. Any of the following embodiments can be preferably used: an embodiment in which the first optical waveguide 50 is disposed on the optical device 40 as shown in FIG. 2A; an embodiment in which the first optical waveguide 50 is disposed on a side of the optical device 40 as shown in FIG. 2B; and an embodiment in which the first optical waveguide 50 is disposed under the optical device 40 as shown in FIG. 2C.

Particularly preferably used is the embodiment in which the first optical waveguide 50 is disposed on the optical device 40 as shown in FIG. 2A because it is easy to control an amount of light taken out from the optical device is easily controlled. In this case, it is particularly preferable that a layer, for example a layer made of the insulator 30, having a thickness of approximately 30 nm to 50 nm and having a low refractive index, is provided between the optical device 40 and the first optical waveguide 50, because it is easy to control the amount of light taken out from the optical device 40 to the first optical waveguide 50.

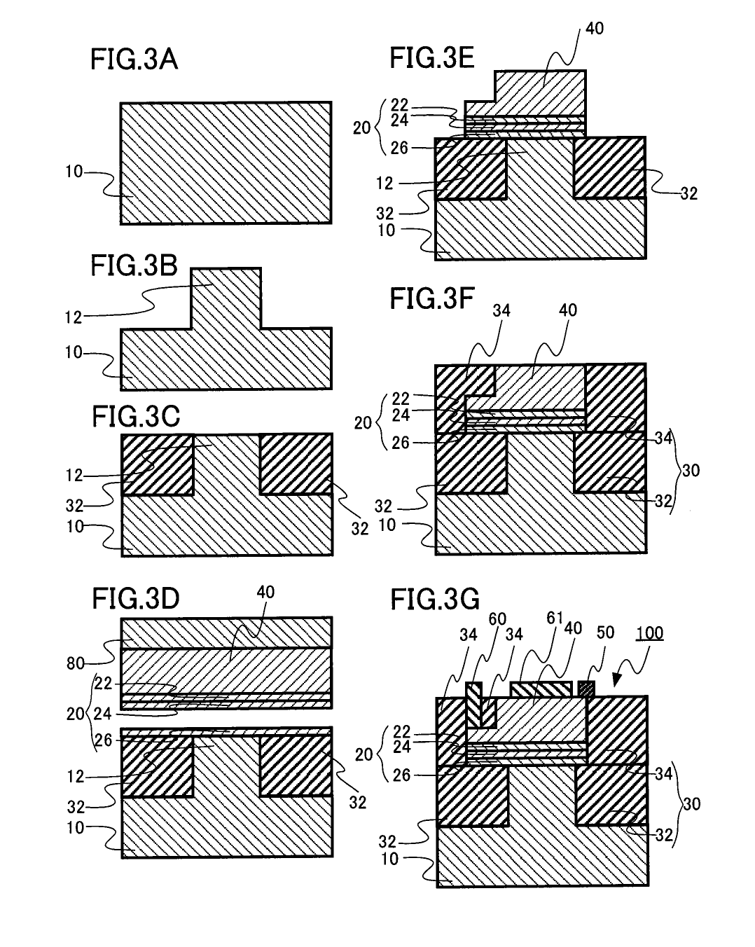

FIGS. 3A to 3G are schematic diagrams showing a method for manufacturing the optical wiring device 100 of the present embodiment. First, on the semiconductor substrate 10 shown in FIG. 3A, the protruding structure 12 is formed, for example by lithography, as shown in FIG. 3B. Next, as shown FIG. 3C, a first insulator 32 is formed around the protruding structure 12.

Next, as shown in FIG. 3D, a base substrate 80 on which the optical device 40 is formed and the semiconductor substrate 10 on which the protruding structure 12 and the first insulator 32 are formed are bonded. As a way of the bonding, it is preferable that the base substrate 80 and the semiconductor substrate 10 are stacked after the surfaces are irradiated with oxygen plasma or argon plasma, for example. It is more preferable that load and heat is applied during the bonding, because it makes the bonding strong.

Further, to maintain the heat dissipation of the optical device 40 and to improve adhesiveness of the optical device 40 to the protruding structure 12, it is preferable that, before the bonding, a first buffer layer 22 made of amorphous silicon or polycrystalline silicon is formed on the optical device 40 and then the formed first buffer layer 22 is planarized.

Further, to maintain the heat dissipation of the optical device 40 and to improve the adhesiveness of the optical device 40 to the protruding structure 12, it is preferable that, before the bonding, a second buffer layer 24 made of metal is formed on the optical device 40.

Further, to maintain the heat dissipation of the optical device 40 and to improve the adhesiveness of the optical device 40 to the protruding structure 12, it is preferable that, before the bonding, the first buffer layer 22 made of amorphous silicon or polycrystalline silicon is formed on the optical device 40, the formed first buffer layer 22 is then planarized, and the second buffer layer 24 made of metal is formed on the planarized first buffer layer 22.

Further, to maintain the heat dissipation of the optical device 40 and to improve the adhesiveness of the optical device 40 to the protruding structure 12, it is preferable that, before the bonding, a third buffer layer 26 made of metal is formed on the semiconductor substrate 10 on which the protruding structure 12 is formed.

Here, each of the planarization is preferably performed by CMP (Chemical Mechanical Polishing) or other methods.

The first buffer layer 22, the second buffer layer 24, and the third buffer layer 26 together form the buffer layer 20. The combination or material for the buffer layer 20 is not limited to the above, and any combination of known buffer layers and any material can be preferably used.

Next, as shown in FIG. 3E, the base substrate 80 is removed. Next, the first buffer layer 22, the second buffer layer 24, the third buffer layer 26, and the optical device 40 are made to have predetermined shape by, for example, photolithography. Next, as shown in FIG. 3F, a second insulator 34 is formed on the optical device 40 and the first insulator 32, and an upper part of the second insulator 34 is then planarized. The first insulator 32 and the second insulator 34 form the insulator 30.

Next, as shown in FIG. 3G, the lower electrode 60 is formed to be electrically connected to the lower part of the optical device 40, and the upper electrode 61 is formed to be electrically connected to the upper part of the optical device 40. In addition, on the second insulator 34, the first optical waveguide 50 is formed to be optically coupled to the optical device 40. This step completes the optical wiring device 100.

In the followings, operation and effect of the present embodiment will be described.

For example, if the optical device 40 is disposed on the semiconductor substrate 10 through a layer such as organic material and oxide, which have a poor heat dissipation performance, heat generated in the optical device 40 is not dissipated well and the temperature of the optical device 40 thus increases.

For example, if the optical device 40 is disposed directly on the semiconductor substrate 10 which does not have the protruding structure 12 and whose surface is flat, luminous efficiency of the optical device 40 is improved because the semiconductor substrate 10 has a high heat dissipation performance. However, because the refractive index of the semiconductor substrate 10 is high, the light emitted from the optical device 40 is radiated into the semiconductor substrate 10, whereby the light cannot be well introduced into the optical waveguide.

In particular, as the optical device 40 is made smaller, the light emitted from the optical device 40 leaks more to the outside of the optical device 40 without being enclosed in the optical device 40. If the optical device 40 is disposed directly on the semiconductor substrate 10 not having the protruding structure 12, this leakage light is easily radiated into the semiconductor substrate 10. As a result, it is difficult to make the optical device 40 smaller.

If the optical device 40 is disposed on the protruding structure 12, because the protruding structure 12 is made of semiconductor, heat generated in the optical device 40 is well dissipated to the semiconductor substrate 10 through the protruding structure 12. As a result, the luminous efficiency of the optical device 40 is improved.

In addition, if the insulator 30 having the refractive index lower than the refractive index of the semiconductor substrate 10 is disposed around the protruding structure 12 and the optical device 40, the light emitted from the optical device 40 is hardly radiated into the semiconductor substrate 10. Thus, the optical device 40 can be manufactured smaller. In addition, the luminous efficiency of the optical device 40 can be further improved.

Because metal, amorphous silicon, and polycrystalline silicon have high elasticity, the optical device 40 can be well bonded on the protruding structure 12 through the buffer layer 20. Further, because metal, amorphous silicon, and polycrystalline silicon each has high thermal conductivity, the heat generated in the optical device 40 can be well diffused into the protruding structure 12 through the buffer layer 20.

The optical waveguide made of amorphous silicon, polycrystalline silicon, or crystalline silicon has a high transmission loss of 1 dB/cm or more. Thus, the optical waveguide made of these silicons is not appropriate for optical wirings for a relatively long distance such as some centimeters to some ten centimeters in which the advantage of optical wirings is noticeable. To address this issue, by using the second optical waveguide made of dielectric or organic material in combination with the optical waveguide made of silicon, it is possible to realize high-capacitance signal transmission with low loss.

According the above-described optical wiring device of the present embodiment, it is possible to provide an optical wiring device which realizes downsizing, high efficiency, and good heat dissipation performance and a method for manufacturing the optical wiring device.

### Second Embodiment

An optical wiring device 200 of the present embodiment includes: a semiconductor substrate having a first protruding structure and a second protruding structure; a light emitting element disposed on the first protruding structure; a light receiving element disposed on the second protruding structure; an insulator disposed around the first protruding structure, the second protruding structure, the light emitting element, and the light receiving element, wherein the insulator has a refractive index lower than a refractive index of the semiconductor substrate; an optical waveguide optically coupled to the light emitting element and the light receiving element; an electric wiring electrically connected to the light emitting element and the light receiving element; and an electronic circuit configured to drive the light emitting element and the light receiving element. In the following description, the same points as in the first embodiment will not be described again.

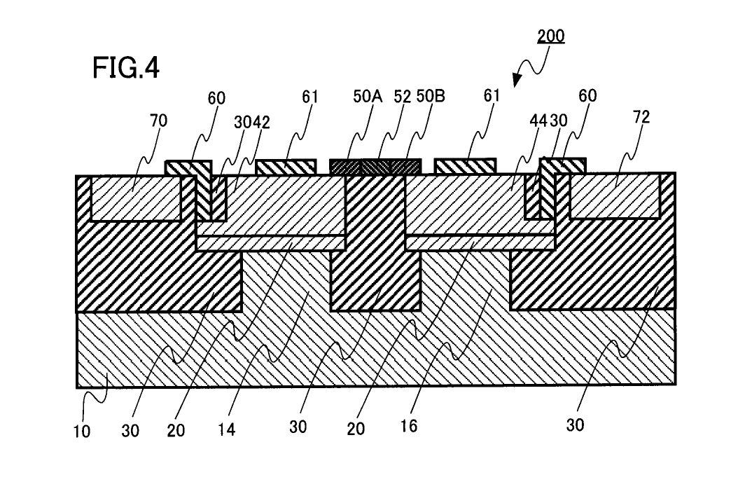

FIG. 4 is a schematic cross-sectional view of the optical wiring device 200 of the second embodiment.

A semiconductor substrate 10 has a first protruding structure 14 and a second protruding structure 16. A light emitting element 42 is disposed on or above the protruding structure 14. In addition, a light receiving element 44 is disposed on or above the protruding structure 14. If the light emitting element 42 and the light receiving element 44 are disposed on the protruding structures, it is particularly preferably that the light emitting element 42 is disposed on the first protruding structure 14 and the light receiving element 44 is disposed on the second protruding structure 16, because, with this arrangement, heat generated in the light emitting element is hardly conducted to the light receiving element. Between the first protruding structure 14 and the light emitting element 42 or between the second protruding structure 16 and the light receiving element 44, the buffer layer 20 may be disposed.

A layer structure of the light emitting element and a layer structure of the light receiving element are preferably the same because the light emitting element and the light receiving element are both easily made at a time by a single epitaxial growth.

Around the light emitting element 42, the light receiving element 44, and the protruding structures 14 and 16, the insulator 30 is disposed. Further, the lower electrode 60 and the upper electrode 61 are disposed to be respectively connected to a lower part and an upper part of each of the light emitting element 42 and the light receiving element 44. Both of the lower electrode 60 and the upper electrode 61 are electric wirings. A first electronic circuit 70 is electrically connected to the light emitting element 42 through the electric wiring. A second electronic circuit 72 is electrically connected to the light receiving element 44 through the electric wiring. Here, the first electronic circuit 70 and the second electronic circuit 72 are LSIs, for example.

The first optical waveguides 50A and 50B are optically coupled to the light emitting element 42 and the light receiving element 44, respectively. Further, a second optical waveguide 52 is disposed to be optically coupled to the first optical waveguides 50A and 50B.

With reference to FIG. 4, a signal processed in the first electronic circuit 70 is transmitted to the first optical waveguide 50A by the light emitting element 42. The signal is transmitted to the second electronic circuit 72 through the second optical waveguide 52 and the first optical waveguide 50B by way of the light receiving element 44.

According to the present embodiment, electronic circuits, a light emitting element, a light receiving element, and an optical waveguide are integrated, so that, even if the electronic circuits are located a long distance away, for example, some ten centimeters, from each other, an optical wiring device having a low-loss optical wiring can be realized.

According to an optical wiring device of at least one of the above-described embodiments, the optical wiring device includes: a semiconductor substrate having a protruding structure; an optical device disposed on the protruding structure; an insulator disposed around the protruding structure and the optical device, the insulator having a refractive index lower than refractive index of the semiconductor substrate; and a first optical waveguide optically coupled to the optical device, and thus, an optical wiring device can be provided which realizes downsizing, high efficiency, and excellent heat dissipation performance.

While certain embodiments have been described, these embodiments have been presented by way of example only, and are not intended to limit the scope of the inventions. Indeed, an optical wiring device and a method for manufacturing the same described herein may be embodied in a variety of other forms;

furthermore, various omissions, substitutions and changes in the form of the devices and methods described herein may be made without departing from the spirit of the inventions. The accompanying claims and their equivalents are intended to cover such forms or modifications as would fall within the scope and spirit of the inventions.

What is claimed is:

1. An optical wiring device comprising:
a semiconductor substrate having a protruding structure;
an optical device disposed on the protruding structure;
an insulator disposed around the protruding structure and the optical device, the insulator having a refractive index lower than a refractive index of the semiconductor substrate; and
a first optical waveguide optically coupled to the optical device.

2. The device of claim 1, wherein a width of the protruding structure in a plane parallel to a main surface of the semiconductor substrate is not greater than a width of the optical device in the plane parallel to the main surface of the semiconductor substrate.

3. The device of claim 1, wherein a distance between a bottom of the protruding structure and the optical device is not less than λ/n and not more than 5λ/n, where λ is a wavelength of light to be emitted or received by the optical device, and n is a refractive index of the insulator.

4. The device of claim 1, further comprising:
a buffer layer disposed between the protruding structure and the optical device, the buffer layer including at least one material selected from the first group consisting of metal, amorphous silicon, and polycrystalline silicon.

5. The device of claim 1, wherein the optical device comprises an indium phosphide based compound semiconductor and a gallium arsenide based compound semiconductor.

6. The device of claim 1, wherein the first optical waveguide is disposed on the optical device.

7. The device of claim 1, wherein the first optical waveguide comprises at least one type of silicon material selected from the second group consisting of amorphous silicon, polycrystalline silicon, and crystalline silicon.

8. The device of claim 1, further comprising:
an electric wiring electrically connected to the optical device.

9. The device of claim 1, further comprising:
an electronic circuit configured to drive the optical device.

10. The device of claim 1, further comprising:
a second optical waveguide made of dielectric or organic material, the second optical waveguide optically connected to the first optical waveguide.

11. An optical wiring device comprising:
a semiconductor substrate having a first protruding structure and a second protruding structure;
a light emitting element disposed on the first protruding structure;
a light receiving element disposed on the second protruding structure;
an insulator disposed around the first protruding structure, the second protruding structure, the light emitting element, and the light receiving element, the insulator having a refractive index lower than a refractive index of the semiconductor substrate;
an optical waveguide optically coupled to the light emitting element and the light receiving element;
an electric wiring electrically connected to the light emitting element and the light receiving element; and
an electronic circuit configured to drive the light emitting element and the light receiving element.

12. The device of claim 11, wherein a width of the first protruding structure in a plane parallel to a main surface of the semiconductor substrate is not greater than a width of the light emitting element in a plane parallel to the main surface of the semiconductor substrate.

13. The device of claim 11, wherein a width of the second protruding structure in a plane parallel to a main surface of the semiconductor substrate is not greater than a width of the light receiving element in a plane parallel to the main surface of the semiconductor substrate.

14. The device of claim 11, wherein a distance between a bottom of the first protruding structure and the light emitting element or a distance between a bottom of the second protruding structure and the light receiving element is not less than λ/n and not more than 5λ/n, where λ is a wavelength of light to be emitted by the light emitting element or to be received by light receiving element, and n is a refractive index of the insulator.

15. The device of claim 11, further comprising:
a buffer layer disposed between the first protruding structure and the light emitting element or between the second protruding structure and the light receiving element, the buffer layer including at least one material selected form the first group consisting of metal, amorphous silicon, and polycrystalline silicon.

16. The device of claim 11, wherein the light emitting element and the light receiving element are indium phosphide based compound semiconductor and gallium arsenide based compound semiconductor and have identical layer structures.

17. A method for manufacturing an optical wiring device, the method comprising:
forming a protruding structure on the semiconductor substrate;
forming a first insulator around the protruding structure;
forming an optical device on a base substrate;
forming the optical device on the protruding structure by bonding the base substrate having the optical device formed on the base substrate and the semiconductor substrate having the protruding structure and the first insulator formed on the semiconductor substrate;
removing the base substrate;
forming a second insulator on the optical device;
planarizing the second insulator;
forming an optical waveguide optically coupled to the optical device; and
forming an electric wiring electrically connected to the optical device.

18. The method of claim 17, wherein forming the optical device on the base substrate includes:
forming, on the optical device, a first buffer layer made of amorphous silicon or polycrystalline silicon; and
planarizing the first buffer layer.

19. The method of claim 17, wherein
forming the optical device on the base substrate includes forming, on the optical device, a second buffer layer made of metal, and
forming the first insulator around the protruding structure includes forming, on the protruding structure, a third buffer layer made of metal.

20. The method of claim 17, wherein
forming the optical device on the base substrate includes:
forming, on the optical device, a first buffer layer made of amorphous silicon or polycrystalline silicon;
planarizing the first buffer layer; and
forming, on the planarized first buffer layer, a second buffer layer made of metal, and
forming the first insulator around the protruding structure includes forming, on the protruding structure, a third buffer layer made of metal.
